(19) United States
(12) Patent Application Publication
(10) Pub. No.: US 2025/0180067 A1
(43) Pub. Date: Jun. 5, 2025

(54) COMBINED ANTI-FRICTION/HYDRODYNAMIC COMMON SHAFT BEARING SYSTEM AND METHODS OF APPLICATION

(71) Applicant: MACO MACHINERY CO., INC. d/b/a ARTEC MACHINE SYSTEMS, North Branford, CT (US)

(72) Inventor: John B. Amendola, P.E., North Branford, CT (US)

(21) Appl. No.: 18/843,163

(22) PCT Filed: Mar. 7, 2023
(86) PCT No.: PCT/US2023/014706

§ 371 Date: Aug. 30, 2024

Related U.S. Application Data
(60) Provisional application No. 63/338,685, filed on May 5, 2022.

(51) Int. Cl. F16C 21/00; F16C 33/10; F16C 33/66

(52) U.S. Cl. CPC F16C 21/005; F16C 33/1085; F16C 33/6677

(57) ABSTRACT

A combined anti-friction/hydrodynamic common shaft bearing system and method of using the same to prevent reduction of the theoretical life of an anti-friction bearing subjected to axial forces within the system comprising an anti-friction bearing secured to a rotating shaft. A housing carries the shaft and includes a plurality of oil passageways to provide hydrodynamic lubrication to the system. A hydrodynamic thrust bearing is secured to the housing adjacent to the anti-friction bearing, and a one thrust-collar is secured to the rotating shaft adjacent the hydrodynamic thrust bearing, with an axial gap between the thrust-collar and the hydrodynamic thrust bearing. The system inhibits axial forces on the anti-friction bearing which would otherwise cause premature failure of the bearing.

### BACKGROUND OF THE INVENTION

### 1. Field of the Invention

The presented invention is related to combined anti-friction/hydrodynamic bearing assemblies used in common shaft system designs, and more specifically but not limited to bearing assemblies incorporated within rotating assemblies utilizing Cardan shaft coupling systems.

### 2. Description of Related Art

Bearings allow movement of an object on or within another object by extracting designed motion from an entire motion. Combined radial-axial anti-friction bearings or similar anti-friction bearings are incorporated into common shafting systems including gearboxes, generators, compressors, turbines, pumps, etc. While these bearings are designed to carry combination loads which are applied radially (perpendicular to the shaft) and axially (parallel to the shaft), these types of bearings may be more prone to failure from excessive axial forces. Cardan shafts are particularly problematic for these systems, which have been known to impose high axial loads due to high misalignment and to torsional lock-up within the axial floating spline arrangement. This is in large part due to the limitations within the design of combined radial-axial anti-friction bearings, thus, there is a need in the industry for a system which allows for such axial forces within a common shafting system to improve the lifespan of an associated anti-friction bearing.

### SUMMARY OF THE INVENTION

In consideration to the aforementioned problems and deficiencies of the prior art, it is therefore an object of the presented invention to provide a bearing assembly which may still utilize anti-friction bearings but without premature wearing on the bearings which reduces the overall bearing life.

It is another object of the presented invention to provide a combined anti- friction/hydrodynamic bearing common shaft system which can protect the associated anti-friction bearings within the assembly from excessive axial forces.

A further object of the invention is to provide a bearing assembly which can improve the specific axial and radial bearing load(s) of the anti-friction bearing(s) utilized within the system.

Still other objects and advantages of the invention will in part be obvious and will in part be apparent from the specification.

The above and other objects, which will be apparent to those skilled in the art, are achieved in the presented invention which is directed to a combined anti-friction/hydrodynamic bearing common shaft system comprising of a rotating shaft having an upstream portion having a first end, a downstream portion having a second end, and an input/output section therebetween. At least one anti-friction bearing is secured to the rotating shaft. A housing may carry the rotating shaft and comprises a lower housing member having a plurality of oil passageways and an upper housing member for secured placement on the lower housing member. At least one hydrodynamic thrust bearing is secured to the housing adjacent the at least one anti-friction bearing. At least one thrust-collar is secured to the rotating shaft adjacent with the at least one hydrodynamic thrust bearing, creating an axial clearance between the at least one thrust-collar and the at least one hydrodynamic thrust bearing. A lubricating medium provides lubrication of the at least one anti-friction bearing, and the at least one hydrodynamic thrust bearing with the at least one thrust-collar via the plurality of oil passageways within the housing.

The at least one anti-friction bearing, the at least one hydrodynamic thrust bearing, with the at least one thrust-collar may form a bearing arrangement. The bearing arrangement may prevent axial forces from inhibiting the L10 life of the at least one anti-friction bearing within the system. The lower housing member and the upper housing member may comprise arcuate channels for registration of the at least one anti-friction bearing with the housing. The arcuate channels of the lower housing member may include orifices for fluid communication with the plurality of oil passageways. The at least one anti-friction bearing may comprise a roller bearing. The at least one hydrodynamic thrust bearing may further comprise a plurality of projecting portions on an interior arcuate portion of the hydrodynamic thrust bearing. The at least one bearing assembly may comprise a plurality of bearing assemblies, such that one of the plurality of bearing assemblies is disposed on the upstream portion of the system and another of the plurality of bearing assemblies is disposed on the downstream portion of the system.

The presented invention also provides for a combined anti-friction/hydrodynamic common shaft system, comprising a rotating shaft including an upstream portion having a first end, a downstream portion having a second end, and an input/output section therebetween. A first anti-friction bearing may be secured to the rotating shaft upstream portion, and a second anti-friction bearing may be secured to the rotating shaft downstream portion. A housing may carry the rotating shaft comprising a lower housing member having a plurality of oil passageways and an upper housing member for placement on the lower housing member. A first hydrodynamic thrust bearing may be secured to the lower housing member and adjacent to the first anti-friction bearing, and a second hydrodynamic thrust bearing may be secured to the lower housing member and adjacent to the second anti-friction bearing. A first thrust-collar may be secured with the rotating shaft and adjacent to the first hydrodynamic thrust bearing, and a second thrust-collar may be secured with the rotating shaft and adjacent to the second hydrodynamic thrust bearing. The system may include a lubricating medium for hydrodynamic lubrication of the first and second anti-friction bearings, the first and second hydrodynamic thrust bearings, and the first and second thrust-collars via the plurality of oil passageways.

The presented invention further provides a method of preventing degradation of the theoretical L10 life of an anti-friction bearing subjected to axial forces within a common shaft system. The method comprises providing a housing comprising a lower housing member having a plurality of oil passageways and an upper housing member for placement on the lower housing member. A rotating shaft is provided and comprises an upstream portion having a first end, a downstream portion having a second end, and an input/output section therebetween. The method may further comprise securing a first anti-friction bearing to the rotating shaft upstream portion or downstream portion, placing the rotating shaft on the lower housing member, securing a first hydrodynamic thrust bearing to the lower housing member and adjacent the first anti-friction bearing, securing a first thrust-collar to the rotating shaft with the first hydrodynamic thrust bearing such that the first anti-friction bearing, the first hydrodynamic thrust bearing, with the first thrust-collar form a bearing assembly having an axial gap between the first hydrodynamic thrust bearing and the first thrust-collar. The method may further comprise securing the upper housing member to the lower housing member to encapsulate the bearing assembly within the housing, and providing a lubricating medium to establish hydrodynamic lubrication to the bearing assembly via the plurality of oil passageways.

The method may further comprise securing a second anti-friction bearing to the rotating shaft downstream portion or upstream portion, securing a second hydrodynamic thrust bearing to the lower housing member and adjacent to the second anti-friction bearing, with a second thrust-collar to the rotating shaft and adjacent to the second hydrodynamic thrust bearing such that the second anti-friction bearing, the second hydrodynamic thrust bearing, and the second thrust-collar form a second bearing assembly having an axial gap between the second hydrodynamic thrust bearing and the second thrust-collar.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a cross-sectional view of a common shaft system according to an embodiment of the presented invention;

FIG. 2 is a front elevational view of the hydrodynamic thrust bearing of the common shaft system according to the presented invention;

FIG. 3 is a cross-sectional view of the hydrodynamic thrust bearing of FIG. 2, along Section A-A;

FIG. 4 is a side view of the assembled rotating shaft system of the common shaft system of the presented invention;

FIG. 5 is a perspective view of the assembled rotating shaft system of FIG. 4;

FIG. 6 is a cross-sectional view of the common shaft system of the presented invention, incorporating the assembled rotating shaft system of FIG. 4;

FIG. 7 is a partial cross-sectional, perspective view of the common shaft system, depicting the location of the hydrodynamic thrust bearing in the bearing arrangement of the presented invention;

FIG. 8 is a perspective view of the interior housing with installed hydrodynamic thrust bearing of the common shaft system of the presented invention;

FIG. 9 is a perspective view of the housing of the common shaft system of the presented invention;

FIG. 10 is a perspective view of the thrust-collar of the common shaft system of the presented invention;

FIG. 11 is a perspective, partial cross-sectional view of the thrust-collar of FIG. 10; and

FIG. 12 is an enlarged, cross-sectional view of the common shaft system of FIG. 6.

### DESCRIPTION OF THE EMBODIMENT(S)

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various components, these components should not be limited by these terms. These terms are only used to distinguish one component from another. For example, a first element could be termed a second element, and, similarly, a second element could be termed a first element, without departing from the scope of the present invention. As used herein, the singular forms “a”, “an” and “the” are intended to include the plural forms as well, unless the context clearly indicates otherwise. Also, as used herein, the term “and/or” includes any and all combinations of one or more of the associated listed items. It will be further understood that the terms “include” and/or “including” when used herein, specify the presence of stated features, steps, operations, elements, and/or components, but do not preclude the presence or addition of one or more other features, steps, operations, elements, components, and/or groups thereof.

Relative terms such as “below,” “above,” “upper,” “lower,” “horizontal,” “vertical,” “top,” “bottom,” “rear,” “front,” “side,” or the like may be used herein to describe a relationship of one element or component to another element or component as illustrated in the figures. It will be understood that these terms are intended to encompass different orientations of the device in addition to the orientation depicted in the figures.

Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

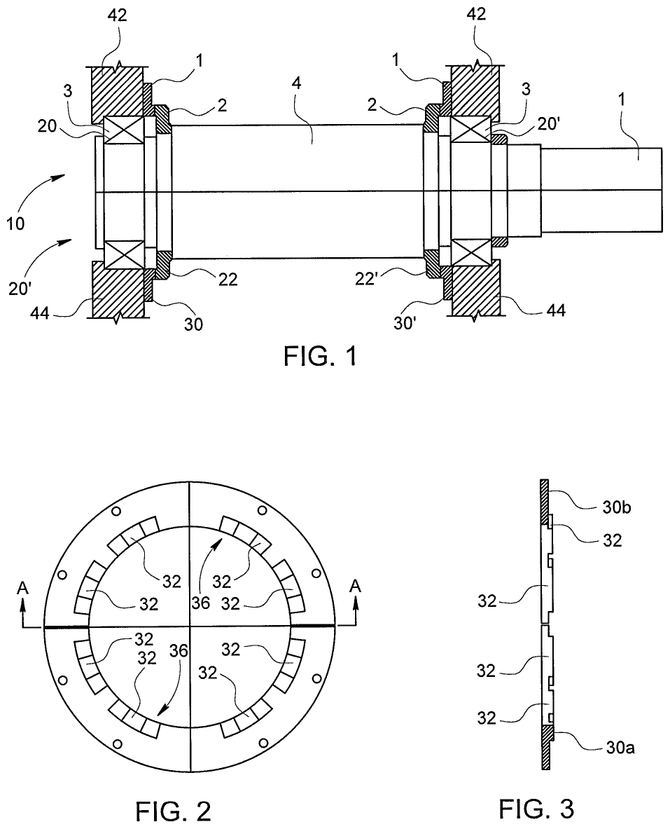

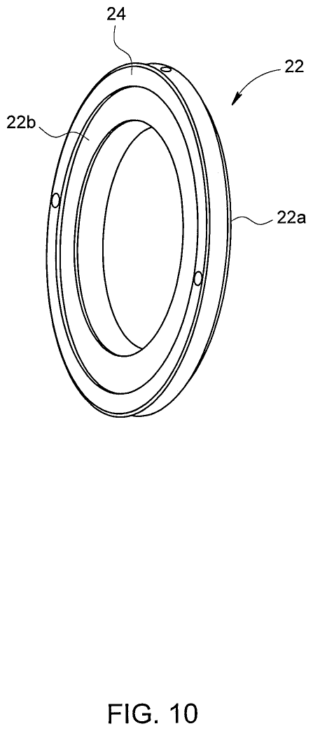

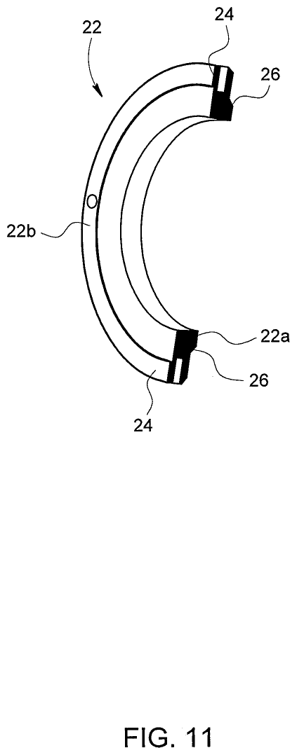

In describing the embodiment of the presented invention, reference will be made herein to FIGS. 1-12 of the drawings in which like numerals refer to like features of the invention. While the embodiments of the invention are illustrated with respect to certain features of common shaft bearing systems, it should be understood that any of the embodiments and/or features thereof illustrated with respect to one embodiment may be utilized with any of the other embodiments and/or features thereof.

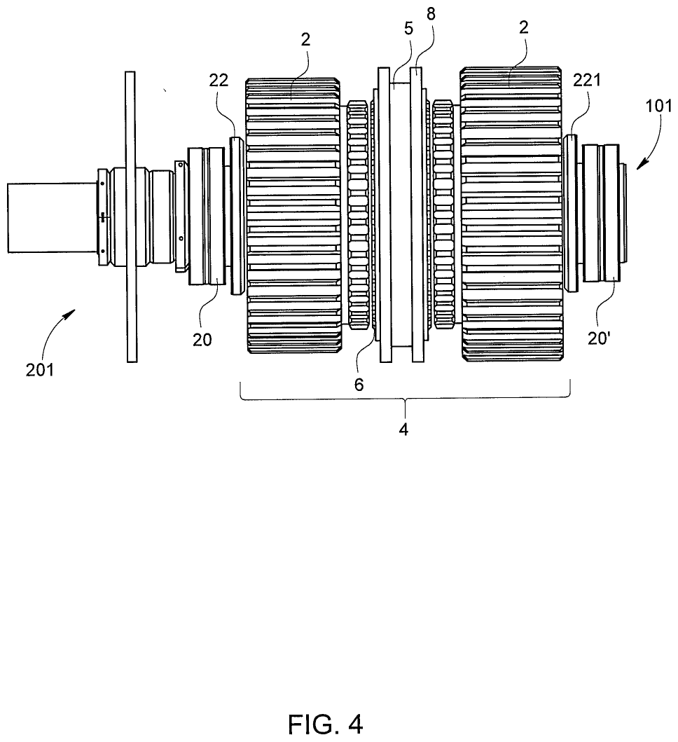

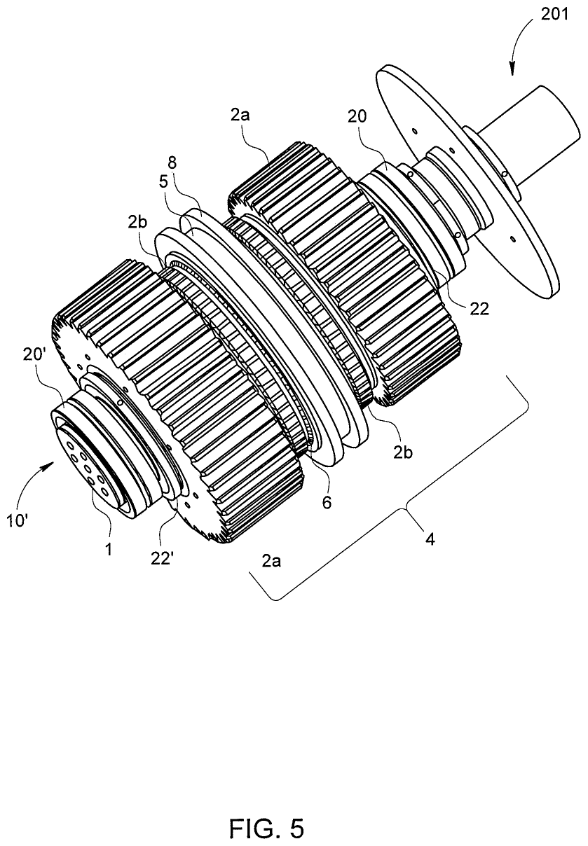

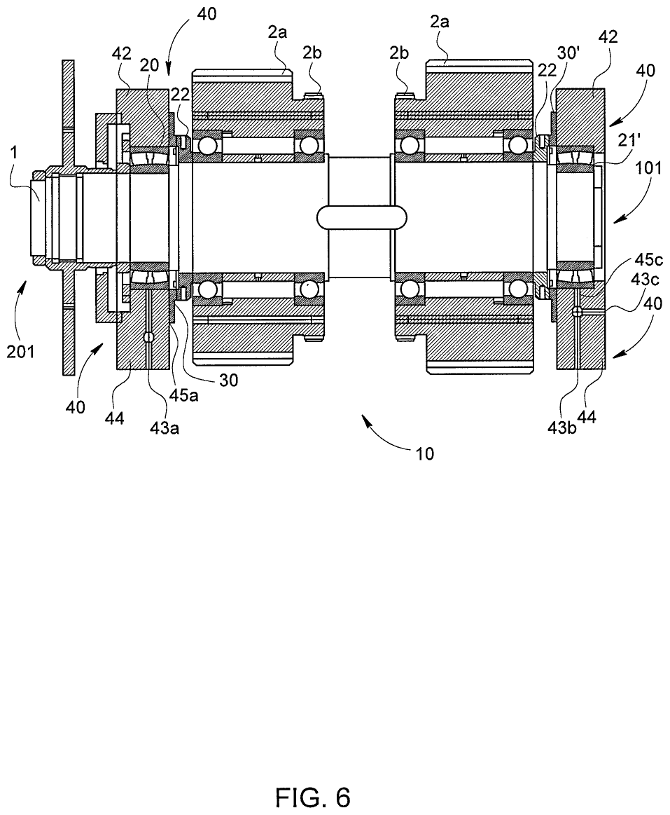

As described further below, common shaft systems 10 (FIG. 1) of the presented invention include bearing assemblies 50, 50′ (see FIG. 6) for a rotating shaft 1 between an input/output assembly 4 (see also FIGS. 4 and 5), which may comprise a gear box, engine, pump, electrical generator, or any other device which may be used by one of ordinary skill in the art.

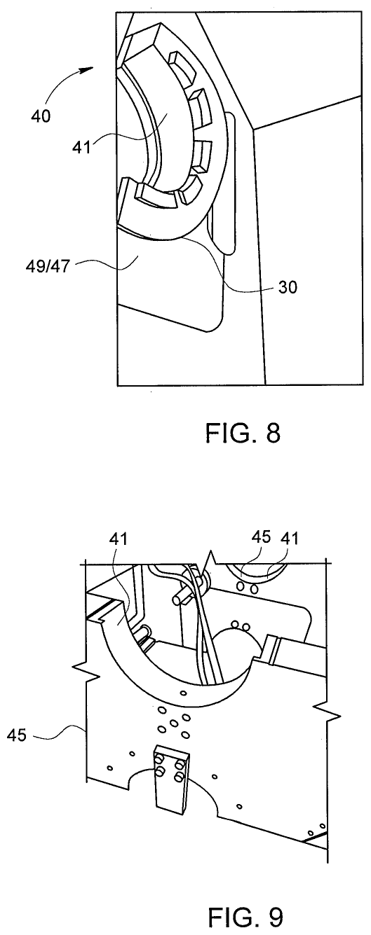

More particularly, a common shaft assembly of the invention comprises an upstream portion 101 and a downstream portion 201 located at opposite ends of the rotating shaft 1. One end of the common shaft assembly may be placed in communication with a driver (e.g., the end proximate upstream portion 101 as depicted in FIGS. 4-6). The assembly may further comprise a load-generating driven element 90, such as a flywheel, cardan shaft, or the like, in communication with a shaft end which would generate an axial load within the system 10. Proximate each end of the rotating shaft 1 supports thereon axial-radial anti- friction bearings 20, 20′, which may comprise spherical roller bearings, straight roller bearings, needle bearings, and the like. The anti-friction bearings 20, 20′ are supported by housing 40, which in turn supports the rotating shaft 1. As further described below and with further reference to FIGS. 8 and 9, the housing 40 may comprise an upper housing member 42 and a lower housing member 44 removably coupled to one another by way of fasteners or any other similar material.

The ends of upper housing member 42 and lower housing member 44 comprise arcuate channels 41 to facilitate registration of the anti-friction bearings 20 within the assembled housing 40, as illustrated in FIGS. 6, 8, 9, and 12. Lower housing member 44 includes one or more oil passageways 43a, 43b, 43c terminating in orifice(s) 45a, 45b on the arcuate channel 41 of the lower housing member 44.

As shown in FIGS. 1, 6, and 7, rotating shaft 1 is central to the system 10, and provides axial motion to operate the input/output section 4. The input/out section 4 may comprise a plurality of toothed gear assemblies 2 incorporating anti-friction bearings for engagement with the rotating shafting shaft 1, and located at opposing sides of the input/output section 4. Each toothed gear assembly 2 comprises a first gear portion 2a having a first diameter, and a second gear portion 2b having a second diameter less than the first diameter. Disposed between the toothed gear assemblies, the input/output section 4 may comprise a gear 6 which may seat flywheel 8, or the like which may include an annular channel 5 for engagement with a belt system or the like.

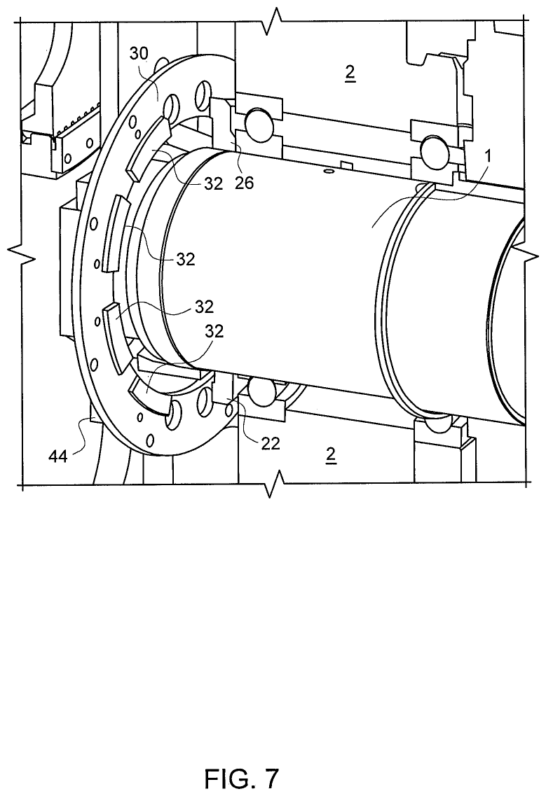

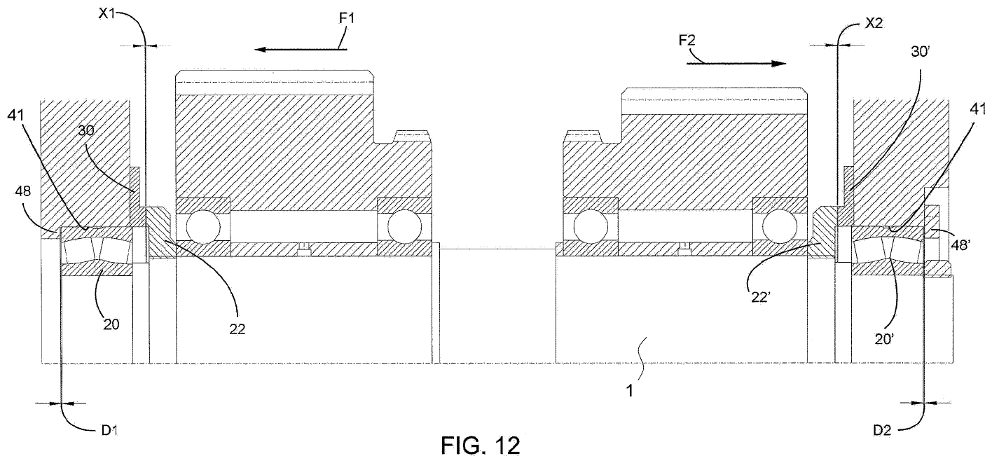

Upon registration of the anti-friction bearings 20 within the arcuate channel(s) 41 of the housing, hydrodynamic thrust bearing 30, which may be an axial-faced tapered land stop ring or the like, is secured to lower housing members 44 at lower inner barrier 49, and to upper housing member 42 at upper inner barrier 47 (See FIGS. 7-9, and 12). Hydrodynamic thrust bearing 30 may be constructed of bronze, copper, aluminum, or any other metal which would be understood by a person of skill in the art. Adjacent to the hydrodynamic thrust bearing 30, a thrust-collar/stop ring 22, disposed on the shaft 1. thrust-collar 22 is of an annular construction and includes a forward face 22a and rearward face 22b. Forward face 22b includes an annular projection 24 along the concentric portion of the stop ring furthest from the radial center of the stop ring (i.e., the outer concentric portion). Rearward face 22a includes an annular ramped portion 26 along the concentric portion of the stop ring closest to the radial center of the stop ring (i.e., the inner concentric portion). Once constructed, a small clearance exists between the projecting portions 32 of the hydrodynamic thrust bearing 30 and the annular projection 24 of the stop ring. In some embodiments, the clearance between the hydrodynamic thrust bearing and the stop ring may be between 0.3-mm to 0.5-mm (±0.1-mm), though other clearance ranges and distances are not meant to be precluded. Thus, the bearing arrangement 50, 50′ of the presented invention comprises an anti-friction bearing 20, 20′ at one end of arrangement, thrust-collar 22, 22′ at the opposite end of the arrangement, with hydrodynamic thrust bearing 30, 30′ placed therebetween (See FIGS. 1 and 12).

Hydrodynamic thrust bearing 30, 30′ comprises two semi-circular plates having a first face 30a and a second face 30b, as well as an interior arcuate portion 36 and an exterior arcuate portion 34. Interior arcuate portion 36 comprises a plurality of projecting portions 32 along the interior arcuate portion 36 of the second face 30b of hydrodynamic thrust bearing 30. While the exemplary plurality of projecting portions 32 depicted in FIGS. 2 and 3 depict flat semi-circular projections, one or more of the projecting portion(s) 32 may be of a sloped, tapered, or similar configuration. As depicted in the cross-sectional views of FIGS. 6 and 7, anti-friction bearing 20 contacts the hydrodynamic thrust bearing 30 at the interior arcuate portion 36 while the first face 30a is secured to lower inner barrier 49 and upper inner barrier 47 via fasteners. Projecting portion 32 facilitates hydrodynamic oil migration between thrust-collar(s) 22, 22′, hydrodynamic thrust bearing(s) 30, 30′, and anti-friction bearing(s) 20, 20′ during operation of the system 10. Upon operation, excessive axial forces will be applied to the complete bearing arrangement 50, 50′, thereby shielding excessive axial forces to the anti-friction bearing(s) 20, 20′ which would ordinarily cause premature failure of the anti-friction bearing(s). As a result, the bearing arrangement can be subjected to higher axial forces before impacting the number of hours in service that 90% of bearings would survive (i.e., the “L10 life,” the preferred term in specifying bearing life as defined by The American Bearing Manufacturers Association).

While typical combined radial-axial anti-friction bearings can withstand some degree of axial forces, external axial forces within the system may be higher than the maximum rated values of the bearing, resulting in rapid degradation of the lifetime of the anti-friction bearings used in the common shaft system. As a result, the bearing L10 life is significantly depreciated when incorporated within these types of common shaft systems. The bearing arrangement of the presented invention shields the anti-friction bearing(s) 20, 20′ within the common shaft system 10 from external axial forces, allowing anti-friction bearings used within the common shaft system to operate without depreciation of the bearing's theoretical L10 life.

By way of example while not intending to be limiting, a common shaft system which includes combined radial-axial anti-friction bearings without incorporating bearing arrangement of the presented invention could be rated for a maximum radial force of 82.2-kN and have a maximum axial force rating of approximately 5-10% of the maximum radial force, such as an axial force rating of 6.0-kN, or a specific bearing load of 0.49N/mm². Since common shaft systems, including Cardan shaft systems, are often subjected to external axial forces much greater than 6.0-kN, the L10 life of bearings within the system can be significantly depreciated. The unexpected result of the bearing arrangement of the presented invention is the bearing arrangement can be subjected to axial forces of 18.5-kN (and a specific bearing load of 1.5N/mm²) or higher without any negative consequences to the L10 life of the combined radial-axial anti-friction bearings within the system.

As shown by FIGS. 6 and 9, the lower housing member 44 is provided with oil passageways 43a, 43b and 43c which allow the movement/egress of oil via housing orifices 45a, 45b to the anti-friction bearing(s) 20, 20′, the hydrodynamic thrust bearing(s) 30, 30′, and the stop ring(s) 22, 22′, respectively. During operation of the system 10, the lubrication medium within the oil passageways to the bearing assembly 50, 50′ is shielded from excessive loads, by virtue of utilizing hydrodynamic common shaft system 10.

Turning now to FIG. 12, assembly of the common shaft system 10 begins with seating the anti-friction bearing(s) 20, 20′, thrust-collar(s) 22, 22′, as well as the input/output section 4 (see FIG. 4) onto the rotating shaft 1, and securing the hydrodynamic thrust bearing(s) 30, 30′ to the housing member(s) lower inner barrier 49 and upper inner barrier 47 (FIG. 8). Once supported by the rotating shaft 0, the anti-friction bearing(s) 20, 20′ are placed into the arcuate channels 41 of the lower housing member 44 such that the outer race of one anti-friction bearing 20 includes an axial clearance gap D1 to the channel sidewall 48 on the downstream portion 201 approximately equal to the axial clearance gap D2 between the outer race of bearing 20′ and channel sidewall 48′ on the upstream portion 101. Values D1 and D2 may then be measured and recorded. Hydrodynamic thrust bearing(s) 30 and 30′ may then be removed from the housing and machined on second face 30b such that upon seating rotating shaft 1 within the housing, axial clearance(s) X1, X2 between the thrust-collar(s) annular projection 24 and the projecting portions 32 of the hydrodynamic thrust bearing(s) 30, 30′ may be maintained during operation. Axial clearance value X1 comprises a value smaller than D1. Likewise, axial clearance value X2 comprises a value smaller than D2. The upper housing member 42 may then be secured to the lower housing member 44 to encapsulate the completed bearing arrangement(s) 50, 50′ within the interior of housing 40, as depicted in FIG. 12. Advantageously, axial loads in generated in directions F1 and F2 may then engage the system at axial clearance(s) X1, X2, allowing axial shifting of anti-friction bearing(s) 20, 20′ within the respective housing(s) during operation without undue over stress resulting from the axial loads.

In one or more embodiments, the clearances between the channel sidewalls 48, 48′ and the outer race of anti-friction bearings 20, 20′ (shown as D1, D2 in FIG. 12), may comprise a distance more than the axial clearances X1, X2. By way of example while not intending to be limiting, the distance measured at X1, X2 (sometimes referred to as a “shaft float”) may comprise a distance of approximately 0.6-mm to approximately 1.0-mm (±0.1-mm), with the distance measured (a.k.a. shaft float) at D1, D2 comprising approximately 1.2-mm to approximately 2.0-mm (±0.2-mm).

During operation of the system, anti-friction bearings 20, 20′ within the shaft system may axially shift/slide within housing arcuate channels 41 resulting from the shaft float at D1, D2. When subjected to axial forces, bearing assemblies 50, 50′ will be subjected to forces which would cause the assembly within the shaft to shift towards the housing in directions F1 and F2. Since shaft float X1, X2 is less than the shaft float D1, D2, contact occurring between the thrust-collar(s) annular projection 24 and the hydrodynamic thrust bearing(s) projecting portions 32 occurs prior to any excessive axial forces applied to the anti-friction bearings 20, 20′. Thus, axial loads encountered by anti-friction bearings 20, 20′ of the bearing assembly 50, 50′ are held to limited values, and the anti-friction bearings will be free to shift within the system without overloading. Advantageously, the system of the presented invention may incorporate anti-friction bearings which would normally be ineffective in applications which would be subject to only radial forces, such as needle bearings.

The common shaft system 10 of the presented invention may be coupled to a Cardan shaft driving, by way of example, a reciprocating pump, gearbox, or the like. In operation, the system may operate at a nominal power of over 3000-kW and a speed of 1000-rpm to 1300-rpm. A person of skill in the art should understand that the system described above is exemplary only, and operation of the system at differing nominal powers and speeds are not meant to be precluded.

Thus, the presented invention provides one or more of the following advantages: a bearing assembly which can utilize anti-friction bearings without premature wearing on the bearings which reduces the L10 bearing life; a hydrodynamic common shaft system which can protect anti-friction bearings within the assembly from excessive axial forces; and a bearing assembly which can improve the specific bearing load of the bearings utilized within the system.

While the presented invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the presented invention.

Thus, having described the invention, what is claimed is:

1. An anti-friction/hydrodynamic common shaft system, comprising:
a rotating shaft comprising an upstream portion having a first end, a downstream portion having a second end, and an input/output section therebetween;
at least one anti-friction bearing secured to the rotating shaft upstream portion and/or downstream portion;
a housing carrying said rotating shaft comprising a lower housing member having a plurality of oil passageways and an upper housing member for placement on the lower housing member;
at least one hydrodynamic thrust bearing secured to the lower housing member and/or upper housing member and adjacent the at least one anti-friction bearing;
at least one thrust-collar secured to the rotating shaft and adjacent to at least one hydrodynamic thrust bearing;
an axial clearance between the at least one thrust-collar and the at least one hydrodynamic thrust bearing; and
a lubricating medium for hydrodynamic lubrication of the at least one anti-friction bearing, the at least one hydrodynamic thrust bearing, and the at least one thrust-collar via the plurality of oil passageways.

2. The anti-friction/hydrodynamic common shaft system of claim 1, wherein the at least one anti-friction bearing, the at least one hydrodynamic thrust bearing, and the at least one thrust-collar form a bearing arrangement, and wherein the bearing arrangement prevents axial forces from inhibiting the L10 life of the at least one anti-friction bearing in the system.

3. The anti-friction/hydrodynamic common shaft system of claim 1, wherein the lower housing member and the upper housing member comprise arcuate channels for registration of the at least one anti-friction bearing with the housing, and wherein the arcuate channels of the lower housing member include orifices for fluid communication with the plurality of oil passageways.

4. The anti-friction/hydrodynamic common shaft system of claim 1, wherein the at least one anti-friction bearing comprises a roller bearing.

5. The anti-friction/hydrodynamic common shaft system of claim 1, wherein the at least one hydrodynamic thrust bearing comprises a plurality of projecting portions on an interior arcuate portion of the at least one hydrodynamic thrust bearing.

6. The anti-friction/hydrodynamic common shaft system of claim 2, wherein the at least one bearing assembly comprises a plurality of bearing assemblies, such that one of the plurality of bearing assemblies is disposed on the upstream portion and another of the plurality of bearing assemblies is disposed on the downstream portion.

7. A method of preventing degradation of the theoretical L10 life of an anti-friction bearing subjected to axial forces within an anti-friction/hydrodynamic common shaft system, comprising:
providing a housing comprising a lower housing member having a plurality of oil passageways and an upper housing member for placement on the lower housing member;
providing a rotating shaft comprising an upstream portion having a first end, a downstream portion having a second end, and an input/output section therebetween;
securing a first anti-friction bearing to the rotating shaft upstream portion or downstream portion;
placing the rotating shaft on the lower housing member;
securing a first hydrodynamic thrust bearing to the lower housing member and/or upper housing member and adjacent the first anti-friction bearing;
securing a first thrust-collar to the rotating shaft and adjacent to the first hydrodynamic thrust bearing such that the first anti-friction bearing, the first hydrodynamic thrust bearing, and the first thrust-collar form a bearing assembly having an axial gap between the first hydrodynamic thrust bearing and the first thrust-collar;
securing the upper housing member to the lower housing member to encapsulate the bearing assembly within the housing; and
providing a lubricating medium to provide hydrodynamic lubrication to the bearing assembly via the plurality of oil passageways.

8. The method of claim 7, wherein the lower housing member and the upper housing member comprise arcuate channels for registration of the first anti-friction bearing with the housing, and wherein the arcuate channels of the lower housing member include orifices for fluid communication with the plurality of oil passageways.

9. The method of claim 7, wherein the first anti-friction bearing comprises a roller bearing.

10. The method of claim 7, wherein the first hydrodynamic thrust bearing comprises a plurality of projecting portions on an interior arcuate portion of the first hydrodynamic thrust bearing.

11. The method of claim 7, further comprising:
securing a second anti-friction bearing to the rotating shaft downstream portion or upstream portion;
securing a second hydrodynamic thrust bearing to the lower housing member and/or upper housing member and adjacent the second anti-friction bearing;
securing a second thrust-collar to the rotating shaft and adjacent to the second hydrodynamic thrust bearing such that the second anti-friction bearing, the second hydrodynamic thrust bearing, and the second thrust-collar form a second bearing assembly having an axial gap between the second hydrodynamic thrust bearing and the second thrust-collar.

12. An anti-friction/hydrodynamic common shaft, comprising:
a rotating shaft comprising an upstream portion having a first end, a downstream portion having a second end, and an input/output section therebetween;
a first anti-friction bearing secured to the rotating shaft upstream portion;
a second anti-friction bearing secured to the rotating shaft downstream portion;
a housing carrying said rotating shaft comprising a lower housing member having a plurality of oil passageways and an upper housing member for placement on the lower housing member;
a first hydrodynamic thrust bearing secured to the lower housing member and adjacent the first anti-friction bearing;
a second hydrodynamic thrust bearing secured to the lower housing member and/or upper housing member and adjacent the second anti-friction bearing;
a first thrust-collar secured to the rotating shaft and adjacent to the first hydrodynamic thrust bearing;
a second thrust-collar secured to the rotating shaft and adjacent to the second hydrodynamic thrust bearing; and
a lubricating medium for hydrodynamic lubrication of the first and second anti-friction bearings, the first and second hydrodynamic thrust bearings, and the first and second thrust-collars via the plurality of oil passageways.

13. The anti-friction/hydrodynamic common shaft system of claim 12, wherein the first anti-friction bearing, the first hydrodynamic thrust bearing, and the first thrust-collar form a first bearing arrangement and the second anti-friction bearing, the second hydrodynamic thrust bearing, and second first thrust-collar form a second bearing arrangement, and wherein the first and second bearing arrangements prevent axial forces from inhibiting the L10 life of the first and second anti-friction bearings in the shaft system.

14. The anti-friction/hydrodynamic common shaft system of claim 12, wherein the lower housing member and the upper housing member comprise arcuate channels for registration of the first and second anti-friction bearings with the housing, and wherein the arcuate channels of the lower housing member include orifices for fluid communication with the plurality of oil passageways.

15. The anti-friction/hydrodynamic common shaft system of claim 12, wherein the first and second anti-friction bearings comprise roller bearings.

16. The anti-friction/hydrodynamic common shaft system of claim 12, wherein the first and second hydrodynamic thrust bearings each comprise a plurality of projecting portions on an interior arcuate portion of each of the first and second hydrodynamic thrust bearings.
